(19) United States
(12) Patent Application Publication
(10) Pub. No.: US 2006/0046919 A1
(43) Pub. Date: Mar. 2, 2006

(54) Method of indexing a preform comprising lugs during the production of a container and station and device used for same

(76) Inventors: Jean-Francois Meyer, Vittel (FR); Jean-Paul Cerveny, Vittel (FR); Bernard Mailfert, St Remimont (FR)

Correspondence Address: YOUNG & THOMPSON, 745 SOUTH 23RD STREET, 2ND FLOOR, ARLINGTON, VA, 22202, US

(21) Appl. No.: 10/521,603

(22) PCT Filed: Jul. 10, 2003
(86) PCT No.: PCT/FR03/02184

§ 371 Date: Jul. 26, 2005

(30) Foreign Application Priority Data
Jul. 16, 2002 (FR) 02/08996

(51) Int. Cl. B31B 1/60

(52) U.S. Cl. 493/394

(57) ABSTRACT

A method of indexing a preform (1) includes anchoring lugs (2) which project out from the body of the preform, the method being used when a container, such as bottle, is being produced from the preform by blowing or blowing/drawing. The method includes a heating step which is performed prior to the blowing or blowing/drawing step, whereby the preform is disposed on a transport support such that it can be rotated around the longitudinal axis thereof. Following the heating step, the preform is transferred to a corresponding mould (300) by a transfer clamp (210). The indexing step consists in mechanically blocking the rotation of the preform on the transport support thereof at a precise angular position which is determined according to the desired position of the preform in the mould (300).

The present invention relates to the field of production of a certain type of polyester containers, preferably of polyethylene terephtalate (PET), from a preform specific to said container.

More precisely, the present invention relates to a process as well as an indexing device for preforms provided with one or several externally projecting elements before their blowing or their blow-drawing for the production of a corresponding container in a suitable blowing installation.

Thus, the French patent application 99 06040 in the name of the applicant proposes a new type of preform particularly useful for the production of containers adapted to be provided with a transport handle or the like.

These preforms are distinguished from conventional preforms conventionally having a cylindrical tubular shape closed at one of its ends, to the extent that they are provided at their open end (which is to say at the neck of the receptacle) with one or several, preferably two, projecting lugs directed outwardly of said preforms.

As explained in French patent application No. 99 06040, this technical solution permits providing a handle extruded from said lugs according to the preform during injection molding.

These lugs can have various geometric shapes and are in principle made from the same material as the rest of the body of the preform, preferably of PET.

The principal function of these lugs is to serve as means for attaching a handle, strap or the like adapted to facilitate the transport and/or the handling of the container obtained by blowing said preform. Such a transport handle will be seen to be all the more advantageous as the container is large and hence heavy when it is full. By way of example, the handles in the form of a ribbon are used to transport bottles of water whose content exceeds 2-3 liters, in particular carboys of mineral water of 5 liters.

In the course of the conventional process for producing a container from a conventional preform (without lugs), the preforms are threaded in series on cylindrical blocks of an endless conveyor chain which thus transports the preforms to the blowing or blow-drawing installation.

Along their path toward this blowing, the preforms pass inverted into an oven essentially constituted by a rectilinear section boarded on each side by radiation heating means, so as to prepare the plastic material for the blowing or blow-drawing step that follows. So as to ensure the most homogeneous distribution of heat possible, the cylindrical blocks on which the preforms are mounted are driven, in addition to their movement toward the blowing machine (principally in translation in a horizontal plane), with a movement of rotation about the longitudinal axis of the cylindrical body of the preform.

The speed of rectilinear movement and of rotation of the preforms, the length and the power of the oven, are calculated such that the temperature of the preform at the outlet of the oven will be slightly greater than that required within the blowing mold, so as to take account of cooling which takes place over the distance between said oven and said blower.

The hot preform is then removed by its neck by a gripper mounted at the end of a mechanical arm called a “transfer arm”, the cylindrical block withdrawing at the same time below said preform. The movement of the transfer arm toward the mold is coordinated with that of the blowing machine which is generally in the form of a rotatable carousel turning continuously about its vertical axis and which carries at its periphery a series of identical molds. Thus, the preform is placed in the mold immediately after the latter has been opened and the previously formed container has been withdrawn by another system of analogous arm.

Thanks to the rotatable movement and the simultaneous presence of several molds, such a blowing machine permits producing containers at a very high rate, of the order of several tens of thousands of units per hour.

However, when it is desired to apply this process of production to containers having preforms of the type described above (preforms with lugs) there arises the problem of orienting the lugs of the preform when the latter is placed in the mold.

Thus, because of the rotation of the preform during its passage through the oven, the lug or lugs on the sides of the body of said preform can be found in any angular position, for example relative to the axis of movement of the preforms, and hence also in the mold and then on the final blown container.

However, it would be necessary at least desirable to be able to control (index) the orientation of said lug or lugs of the preform such that these latter will be located adjacent the position or positions desired on the final container, in particular when this latter is not a figure of revolution.

Such is particularly the case for square or rectangular carboys whose expanded body has essentially four surfaces that are more or less flat.

The problem solved by the present invention consists accordingly in overcoming the drawbacks mentioned and in providing a process and an indexing or orienting device of preforms with lugs, which will be both simple and effective.

To solve this problem, the invention provides a process for indexing a preform provided with at least one hooking lug projecting outwardly of the body of said preform, during a process of production of a container, for example of polyester resin, from said preform, comprising essentially a step of heating said preform before the principal blowing or blow-drawing step of said preform during which said preform is moved along transport support permitting its rotation about its longitudinal axis, characterized in that it consists, between said step of heating said preform and the step of blowing or blow-drawing of said preform, in mechanically blocking the rotation of said preform on its transport support in a precise angular position for at least one hooking lug, said angular position of the hooking lug after blocking being determined as a function of a predetermined desired position of said hooking lug of said preform after its transfer by means of a transfer gripper into the blowing or blow-drawing mold.

In this way, each preform is located in a predetermined angular position at the output of the heating step. The movement of the gripper being always the same, there thus corresponds to the angular position of the preform at the end of the heating step a corresponding angular position of the preform in the mold. It suffices, knowing the movement of the gripper, to fix the angular position of the preform at the exit from the heating step as a function of the desired angular position of the preform within the mold. The step of mechanically blocking the rotation of the preform thus comprises an indexing step ensuring the control of the orientation of the lug or lugs of this preform.

According to one aspect of the present invention, the orientation of at least one hooking lug of said preform relative to said transfer gripper during said transfer toward the blowing or blow-drawing mold, remains unchanged.

Once the transfer gripper closes over the preform, this latter is gripped between the arms of the gripper and cannot turn relative to these arms. According to the invention, the angular position of the preform after blocking is determined as a function of the desired angular position in the mold, having regard for the movement of the gripper.

Alternatively, the orientation of at least one hooking lug of said preform relative to said transfer gripper during said transfer toward the blowing or blow-drawing mold, can be modified by rotation of the preform about its longitudinal axis.

This step permits by reorientation of the preform before its introduction into the mold. Such a step can serve to modify the orientation of the preform in the mold, for example when it is desired to obtain blown containers with different orientations of lugs. It can also serve as a second indexing step in the case in which the step of mechanically blocking the preform after the step of heating leaves a certain uncertainty as to the angular position of the preform in the gripper. For example, the step of mechanically blocking of the preform after heating, forming the step of pre-indexing, can permit fixing the orientation of the lug or lugs of the preform with an uncertainty of more or less 15°. The step of re-orientation, thus forming the step of final indexing, permits fixing much more precisely the orientation of the preform in the gripper and as a result the orientation of the lug or lugs relative to the final blown container.

According to another aspect of the present invention, the hooking lug or lugs are made in the form of pieces whose portion connected to said preform has a reduced cross-section relative to the retaining means forming the free end of said lug.

Preferably, two hooking lugs are present on the neck of said preform.

Preferably, said preform comprises two diametrically opposed hooking lugs forming a single piece with said preform, which is to say formed of a single piece with this latter.

Preferably, the hooking lug or lugs has substantially a flat elongated shape in the form of a bean (oblong structure) with two rounded ends of circular shape.

Preferably, at the end of the production process, there is provided at the end of the production process on the forms container, a gripping end or transport means using or coming into engagement with the hooking lug or lugs.

According to another aspect of the present invention, there is provided an indexing station for the practice of the process defined above, characterized in that it comprises mechanical blocking means adapted mechanically to block the rotation of said preform after said heating step.

Preferably, said mechanical blocking means comprises an immobilization means of a hooking lug of a preform subject to the conjugated actions of the drive means in translation and of a drive means in rotation, said immobilization means being adapted to hold said lug in a substantially fixed position whilst said preform continues to move in the direction of translational movement while turning about its axis so as to carry out substantially a pivoting relative to said lug, independently of the rotational drive means, said immobilization means being adapted to free said lug when the latter is located in its precise angular position.

Preferably, said drive means in rotation is deactivated, for a given preform, at a position of said preform in which a lug of said preform is located necessarily immobilized in said immobilization means.

According to another aspect of the present invention, said mechanical blocking means is in the form of a rigid cam against the surface of which the hooking lug can come to bear in the course of its movement by the corresponding transport support.

Preferably, said rigid cam comprises a first flat surface against which comes to bear a hooking lug of preform subject to the conjugated actions of a drive means in translation and a drive means in rotation, said cam surface extending parallel to the direction of driving in translation such that said preform is immmobilized in rotation whilst remaining free to move in translation.

Preferably, said rigid cam comprises a retracted surface forming a hollow adapted to receive a hooking lug of a preform so as to form an immobilization means adapted to maintain said lug in a substantially fixed position whilst said preform continues to move in a direction of turning movement about its axis so as to carry out substantially a pivoting relative to said lug.

Preferably, said retracted surface comprises a shoulder against which a lug of a preform can come to bear so as to immobilize said lug until said preform will not be subject to the action of a drive means in rotation.

Preferably, said retracted surface comprises a slant inclined relative to the direction of driving in translation, said lug being located in said hollow or reinforcement formed by said retracted surface coming to bear against said inclined slant until said lug is located in said precise angular position.

Preferably, said rigid cam comprises a second flat surface against which comes to bear a hooking lug of a preform located in said precise angular position, said second flat surface extending parallel to a drive direction in translation such that said preform is immobilized in rotation whilst remaining free to move in translation.

Preferably, said retracted surface is located between said first and second flat surfaces, said retracted surface being disposed facing a zone in which the drive means in rotation of the preforms is deactivated.

Preferably, said second flat surface is located offset laterally outwardly relative to said first flat surface, which is to say in the direction of the retracted surface.

According to another aspect of the present invention, the drive means in rotation for the preforms is an endless chain of which a drive portion circulates parallel to a direction of is driving in rotation of said preforms at a speed greater than the speed of driving in rotation of said preforms, said endless chain being in engagement with toothed drive wheels in rotation for the support means of the preforms so as to cause the rotation of said preforms about their axes.

Preferably, the zone in which the drive means in rotation of the preforms is deactivated corresponds to a toothed wheel for changing the direction of said endless chain.

The present invention also provides an indexing device for the practice of the process defined above, in cooperation with the indexing station defined above, characterized in that it comprises essentially a drive means in limited rotation of a preform when this latter is gripped in said transfer gripper.

Preferably, said drive means in rotation is in the form of a movable abutment associated with said gripper and adapted to bear against at least one of said lugs so as to give rise to the rotation of said preform.

Preferably, said movable abutment has a U shaped structure and comprises two arms of different lengths adapted to bear against two diametrically opposite lugs when said preform is in a predetermined angular position, one or the other arm coming to bear against the corresponding lug to drive in rotation said preform in said precise predetermined angular position in the case in which said preform is spaced from this position in one or the other directions, respectively.

Finally, the invention also has for its object an installation for the production of containers by blowing or blow-drawing of preforms, characterized in that it comprises an indexing station according to the invention and, as the case may be, an indexing device according to the present invention.

The invention will be understood from the following description, which relates to a preferred embodiment, given by way of non-limiting example, and explained with reference to the accompanying schematic drawings, in which:

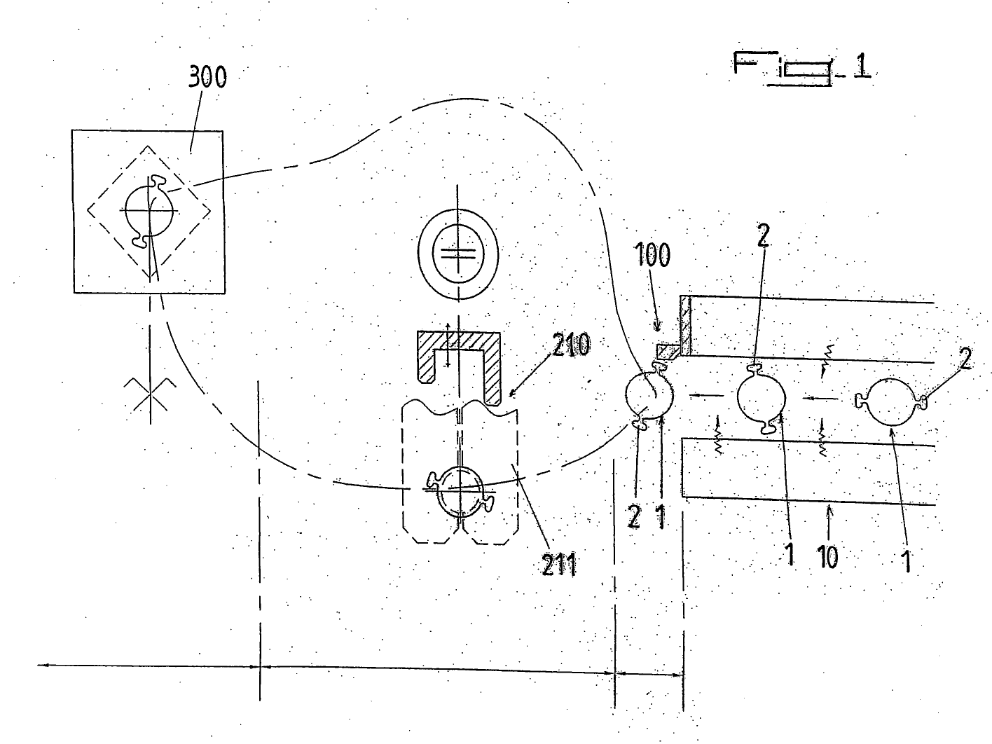

FIG. 1 is a diagram of a device for producing bottles provided with indexing devices according to the present invention;

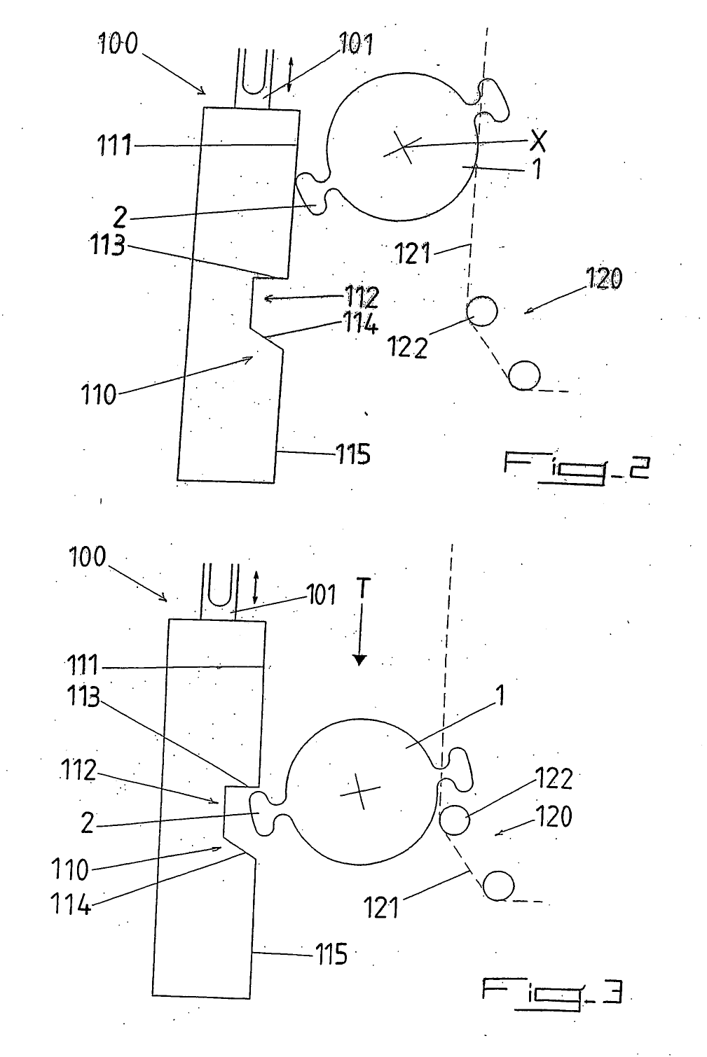

FIGS. 2 to 6 are fragmentary schematic views representing the different stages of progress of a preform at the outlet of a heating oven of the production device of FIG. 1, provided with an indexing station according to the present invention; and

FIG. 7 is a schematic representation of a transfer gripper of the production device of FIG. 1 provided with an indexing device according to the present invention, in addition to the indexing station shown in FIGS. 2 to 6.

The present embodiment is used in the framework of a known device for producing bottles of polyethylene terephtalate (PET) from a preform, the bottles being adapted to be provided with a transport handle or the like as is described in French patent application No. 99 06040 in the name of the applicant.

Referring to FIG. 1, a preform 1 has the shape of a cylindrical tube closed at one of its ends and provided at its opened end with two projecting lugs 2 directed radially outwardly of the preform. Each lug 2 is in the form of a flat piece whose portion connected to the preform 1 has a cross-section reduced relative to the retaining means forming the free end of this lug, having substantially a flat elongated shape in the form of a bean with two rounded ends lying on its circles. The two lugs 2 are diametrically opposed. They form a single piece with the preform 1.

In known manner, the preforms 1 are placed one by one over cylindrical blocks, forming transport supports, on an endless conveyor chain which transports the preforms 1 upside down through an oven 10 essentially constituted by a rectilinear section bordered on each side by radiation heating means. The cylindrical blocks on which the preforms 1 are mounted are rotatably mounted so as to drive the preforms in rotation about their axes. Each of these blocks is provided with a toothed wheel (not shown) for driving in rotation.

As can be seen in FIGS. 2 to 6 with respect to FIG. 1, the device 120 for driving in rotation the preforms 1 is constituted by an endless chain 121 of which a portion circulates in the oven 10 parallel to the driving direction in translation of the preforms. This chain 121 moves with a speed greater than the speed of driving in rotation of the preforms. For example, if this latter speed is V, the chain moves at a speed, for example, of 2V or another multiple of V. This chain coming into engagement with the toothed wheels of the cylindrical blocks on which the preforms are threaded, gives rise to the rotation about their axes X (vertical) of these latter. At the outlet of the oven 10, the chain 121 moves away from the conveyor chain for the preforms 1, and wheel 122 causing the inclination of the chain outwardly and hence forming a zone from which the device 120 for driving in rotation of the preforms is deactivated.

The hot preform 1 is gripped at the neck and removed by a gripper 200 mounted at the end of a mechanical arm called a “transfer arm”, the cylindrical block withdrawing at the same time downwardly from the preform. The movement of the gripper 200 toward the mold 300 is coordinated with the movement of the blowing machine containing this mold. In a well-known manner, the blowing machine is in the form of a rotatable carousel turning continuously about its vertical axis and carrying at its periphery a series of identical molds 300. The preform is placed in the mold immediately after this has been opened and the preceding form container has been withdrawn by another system of an analogous arm.

According to the invention, an indexing station 100 is provided at the outlet of the oven 10. This is essentially a mechanical blocking means adapted to block mechanically the rotation of a preform 1 at the outlet of the oven 10 so that the lugs 2 of this preform 1 will be located in a precise angular position when the gripper 200 closes over this preform.

The indexing station is described in greater detail with reference to FIG. 2 to 6.

Overall, the mechanical blocking means 100 is in the form of a rigid cam 110 against the surface of which the lug 2 of a preform 1 comes to bear. The cam 110 is mounted at the end of an arm 101 bolted on a panel of the oven 10. The cam 110 is itself bolted on the arm 101 at the level of an oblong hole provided in this arm, which permits adjusting the position of the cam 110 relative to the oven 10.

The surface of cam 110 comprises, seen in the direction of translation T, a first flat surface 111, a retracted surface 112 and then a second surface 115. The flat surfaces 111 and 115 extend vertically parallel to the direction of translation T of the preforms 1, the flat surface 115 being slightly offset laterally externally relative to the flat surface 111. The retracted surface 112 forms a hollow whose difference of level relative to the first surface 111 forms a shoulder 113 and whose difference of level with respect to the second surface 115 forms an inclined slant 114. The retracted surface 112 is located substantially facing a zone of direction change of the chain 121 giving rise to deactivation of the device 120 for driving in rotation for a preform passing through this zone.

When a preform 1 leaves the oven 10, it is driven both in translation by the conveying device (not shown in the accompanying figures) and in rotation by the action of the device 120 for driving in rotation. The distance between the first cam surface 111 and the axis of rotation X of the preform 1 being less than the distance between this axis X and the end of a lug 2, one of the to lugs 2 of the preform 1 will necessarily come into contact with the cam surface 111, as can be seen in FIG. 2. Because of this, despite the action of the device for driving the preform in rotation, the preform 1 will be immobilized in rotation, disengaging, at least in rotation, from the movement of its support block.

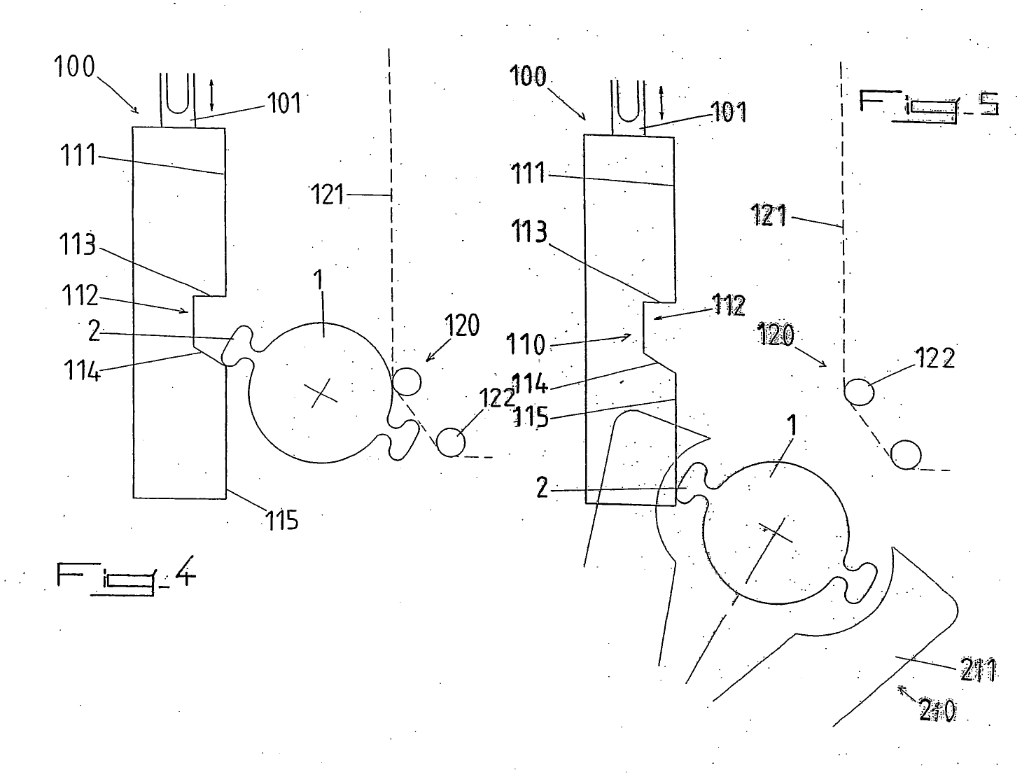

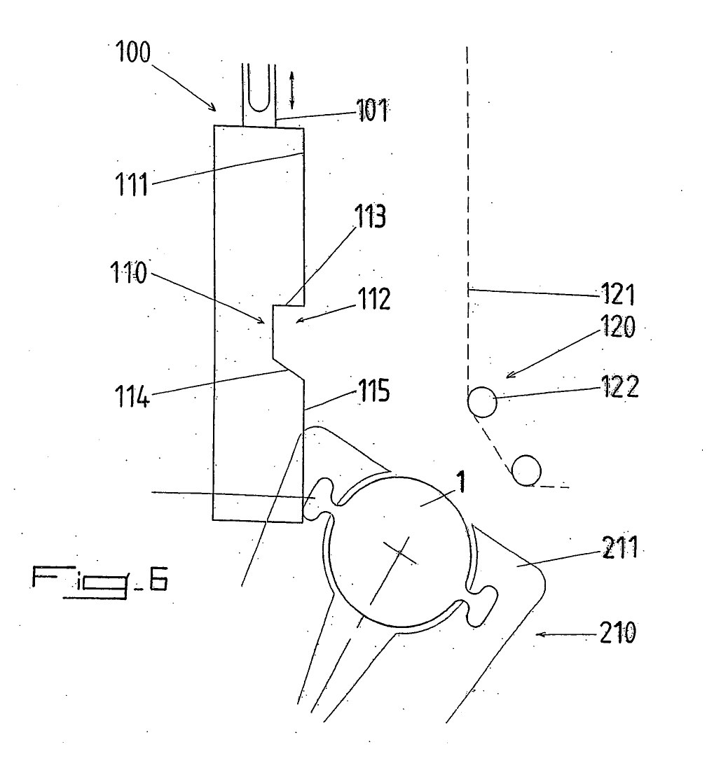

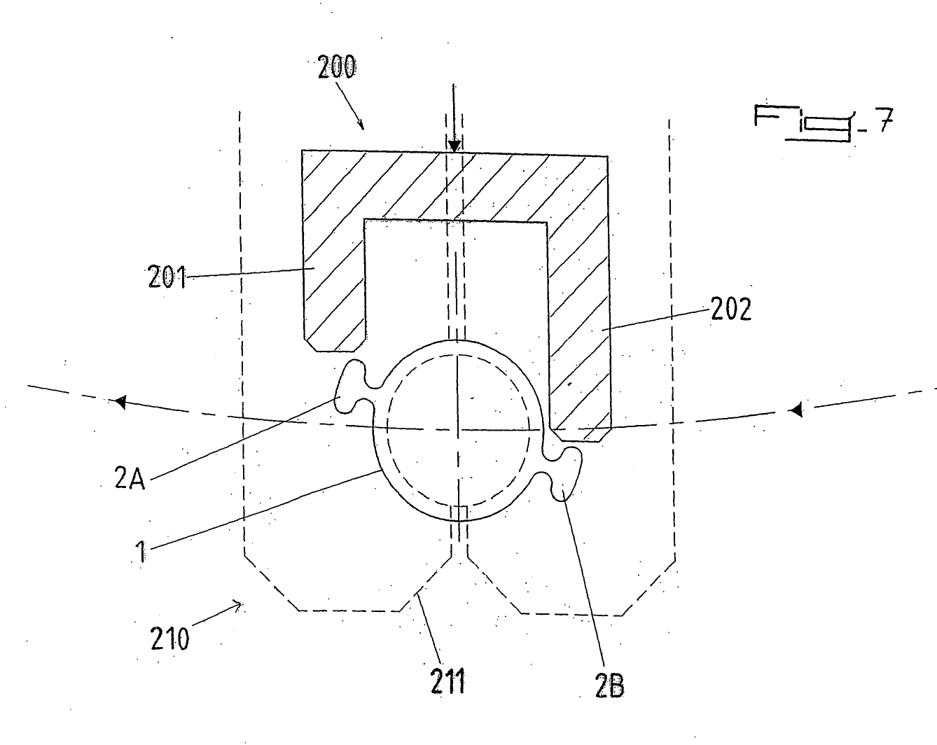

The preform 1, driven by the conveying device, will then continue its movement, the lug 2 sliding against the cam surface 111 until it arrives at the hollow 112. There, as can be seen in FIG. 3, the lug 2 will be introduced into the hollow 112. Still urged by the means 120 for driving in rotation, the lug 2 will bear against the shoulder 113. The hollow 112 forms an immobilization means for the lug 2 adapted to maintain this lug in a substantially fixed position. The preform 1, driven by the conveying device, continues to move longitudinally, which is to say in the direction of driving in translation T. However, because the lug 2 is substantially immobilized by the hollow portion 112, the preform 1 will turn about its axis so as to carry out substantially a pivoting movement relative to said lug. This rotation of the preform 1 about its axis takes place independently of the means 120 for driving in rotation, even if this latter continues to urge the preform. The pivoting about the lug 2 takes place until this latter will be able to pass the inclined slope 114. To do this, it is necessary that this lug have a certain inclination, shown in FIG. 4. The chain 121 being deflected by the wheel 122, the device 120 for driving in rotation will no longer act on the preform 1 when this latter is located in the position shown in FIG. 4. The device 100 is adjusted such that the angular position of release of the lug will be the precise angular position that it is desired to have at the end of the indexing process. Then, the preform 1 will continue its translation, the lug 2 sliding against the cam surface 115 until the final position shown in FIG. 5. The jaws 211 of the gripper 210 will then close on the preform 1 as is shown in FIG. 6.

So as to modify the angular position of release of the lug 2 from the hollow 112, the cam 110 can be slightly inclined. This inclination is possible to the extent that it does not give rise to a loss of contact between the lug 2 and the cam surface 111.

The indexing station which has been described permits a relatively precise indexing of the preforms 1 at the outlet of the oven 10. This indexing device can itself be entirely sufficient.

However, under certain circumstances, the indexing can take place with a slight margin of uncertainty as to the orientation of the lugs 2, for example by several degrees.

So as to index even more precisely the orientation of the lugs 2, the invention can use a supplemental indexing device which is shown in FIG. 7 and which comprises overall a means 200 for driving in rotation a preform 1 when this latter is gripped by the transfer gripper 210.

The means 200 for driving in rotation is in the form of a movable abutment associated with said gripper, controlled by a cam and adapted to come to bear against one of said lugs so as to give rise to the rotation of the preform 1. This movable abutment can move but with a movement of translation along the axis of the gripper, in the direction of preform 1. This movable abutment comprises two arms 201 and 202, of a spacing slightly greater than the diameter of the preform 1 and of different lengths. The difference of length between the arms 201 and 202 is selected as a function of the orientation that it is desired to give to the lugs 2A and 2B. When the lugs 2A and 2B are in the desired orientation, the arms 201 and 202 come to bear against one and the other of the lugs 2A and 2B, respectively. In this example shown in FIG. 7, when the preform 1 leaves the desired orientation by a positive angle, the arm 202, the longer, will bear against the lug 2B which is located on its side until the other lug 2A comes into contact with the arm 201, the shorter. Conversely, when the preform 1 departs from the desired orientation by a negative angle, the arm 201, the shorter, comes to bear against the lug 2A which is located on its side until the other lug 2B comes into contact with the arm 202, the longer.

Finally, the invention also relates to an installation for the production of containers by blowing or blow-drawing of preforms, characterized in that it comprises an indexing station as described above and, as the case may be, an indexing device as previously described.

Of course, the invention is not limited to the embodiment described and shown in the accompanying drawings. Modifications remain possible, particularly as to the construction of the various elements or by substitution of technical equivalents, without thereby departing from the scope of protection of the invention.

1-25. (canceled)

26. Process for indexing a preform (1) provided with at least one hooking lug (2) projecting outwardly from the body of said preform during a process of production of a container, for example of polyester resin, from said preform (1), comprising essentially a step of heating said preform (1) before the principal step of blowing or blow-drawing of said preform (1) during which said preform (1) is moved on a transport support permitting its rotation about its longitudinal axis, and in which, between said step of heating said preform (1) and the step of blowing or blow-drawing said preform (1), the rotation of this latter is mechanically blocked on its transport support in a precise angular position of at least one hooking lug (2), said angular position of the hooking lug (2) after blocking being determined as a function of a predetermined desired position of said hooking lug of said preform (1) after its transfer by means of a transfer gripper (210) into the blowing or blow-drawing mold (300) and characterized in that the orientation of at least one hooking lug (2) of said preform (1) relative to said transfer gripper (210) during said transfer toward the blowing or blow-drawing mold (300) is modified by rotation of the preform about its longitudinal axis when it is gripped in said transfer gripper (210) by a means (200) for limited driving in rotation of a preform (1) in the form of a movable abutment associated with said gripper (210) and adapted to come to bear against at least one of said lugs (2) so as to give rise to the rotation of said preform (1).

27. Process according to claim 26, characterized in that the hooking lug or lugs (2) are in the form of pieces whose portion connected to said preform (1) has a reduced cross-section relative to the retaining means forming the free end of said lug (2).

28. Process according to claim 26, characterized in that two hooking lugs (2) are present on the neck of said preform (1).

29. Process according to claim 26, characterized in that said preform (1) comprises two diametrically opposed hooking lugs (2) forming a single piece with said preform.

30. Process according to claim 26, characterized in that the hooking lug or lugs (2) have substantially a flat elongated shape in the form of a bean with two rounded ends lying on circles.

31. Process according to claim 26, characterized in that it consists, at the end of the process of production, in providing the formed container with a gripping and/or transport means belonging to or coming into engagement with the hooking lug or lugs (2).

32. Indexing station for the practice of the process according to claim 26, comprising principally a mechanical blocking means (100) adapted mechanically to block the rotation of said preform (1) after said heating step, said mechanical blocking means (100) comprising a means (112) for immobilizing said at least one hooking lug (2) projecting outwardly of the body of said preform (1), which is subject to the conjoint actions of a means for driving in translation and means (120) for driving in rotation, said immobilization means (112) being adapted to hold said lug (2) in a substantially fixed position whilst said preform (1) continues to move in the direction of driving in translation while turning about its axis (X) so as to carry out substantially a pivoting relative to said lug, independently of the means (120) for driving in rotation and said immobilization means (112) being adapted to free said lug (2) when the latter is in said precise angular position.

33. Station according to claim 32, characterized in that said means (120) for driving in rotation is deactivated, for a given preform (1), in a position of said preform in which a lug (2) of said preform is necessarily located immobilized in said immobilization means (112).

34. Station according to claim 32, characterized in that said mechanical blocking means (100) is in the form of a rigid cam (110) against the surface of which a hooking lug (2) comes to bear.

35. Station according to claim 34, characterized in that said rigid cam (110) comprises a first flat surface (111) against which comes to bear a hooking lug (2) of a preform (1) subject to the conjugated actions of a means for driving in translation and a means (120) for driving in rotation, said flat surfaces can be parallel to the direction of drive in translation (T) such that said preform (1) is immobilized in rotation whilst remaining free to translate.

36. Station according to claim 34, characterized in that said rigid cam (110) comprises a retracted surface (112) forming a hollow adapted to receive a hooking lug (2) of a preform (1) so as to form an immobilization means adapted to hold said lug in a substantially fixed position whilst said preform continues to move in a direction of drive in translation (T) by turning about its axis (X) in a manner substantially to pivot relative to said lug.

37. Station according to claim 36, characterized in that said retracted surface (112) comprises a shoulder (113) against which a lug (2) of a preform (1) can bear so as to immobilize said lug until said preform will no longer be subject to the action of a means for driving in rotation.

38. Station according to claim 36, characterized in that said retracted surface (112) comprises a slope (114) inclined relative to the direction of driving in translation (T), said lug (2) being located in said hollow or reinforcement formed by said retracted surface (112) coming to bear against said inclined slope (114) until said lug (2) is in said precise angular position.

39. Station according to claim 35, characterized in that said rigid cam (110) comprises a second flat surface (115) against which a hooking lug (2) of a first preform (1) comes to bear in said precise angular position, said second flat surface (115) extending parallel to the direction of driving in translation (T) such that said preform is immobilized in rotation whilst remaining free in translation.

40. Station according to claim 39, characterized in that said retracted surface (112) is located between said first (111) and second (115) flat surfaces, said retracted surface being disposed facing a zone (122) in which the drive means in rotation (120) of the preforms (1) is deactivated.

41. Station according to claim 39, characterized in that said second flat surface (115) is offset laterally outwardly relative to said first flat surface (111).

42. Station according to claim 32, characterized in that the means (120) for guiding in rotation of the preforms (1) is an endless chain (121) whose drive portion circulates parallel to a direction of drive in translation (T) of said preforms (1) at a speed greater than the speed of driving in translation of said preforms, said endless chain being in engagement with toothed wheels for driving in rotation support means for the preforms so as to give rise to the rotation about their axes (X) of said preforms (1).

43. Station according to claim 42, characterized in that the zone in which the means (120) for driving in rotation of the preforms (1) is deactivated corresponds to a toothed wheel (122) for changing the direction of said endless chain (121).

44. Indexing device for practicing a process according to claim 26 in cooperation with an indexing station, characterized in that it comprises essentially a means (200) for driving in limited rotation a preform (1) when this latter is gripped in said transfer gripper (210), said means for driving in rotation being in the form of a movable abutment associated with said gripper (210) and adapted to come to bear against at least one of said lugs (2) so as to give rise to the rotation of said preform (1).

45. Device according to claim 44, characterized in that said movable abutment (200) has a U shaped structure and comprises two arms (201, 202) of different lengths adapted to come to bear against two diametrically opposed lugs (2A, 2B) when said preform (1) is in a predetermined angular position, one or the other arm coming to bear against the corresponding lug to drive in rotation said preform (1) in said predetermined precise angular position in the cases in which said preform is spaced from this position in one or the other directions, respectively.

46. Installation for the production of containers by blowing or blow-drawing of preforms, characterized in that it comprises an indexing station according to claim 32.
